(19) United States
(12) Patent Application Publication
(10) Pub. No.: US 2014/0208306 A1
(43) Pub. Date: Jul. 24, 2014

(54) CONTROL SYSTEM HAVING AUTOMATIC COMPONENT SOFTWARE MANAGEMENT

(71) Applicant: CATERPILLAR INC., Peoria, IL (US)

(72) Inventors: Bibhrajit HALDER, Peoria, IL (US); Andrew Joseph Vitale, Peoria, IL (US)

(73) Assignee: Caterpillar Inc., Peoria, IL (US)

(21) Appl. No.: 13/748,042

(22) Filed: Jan. 23, 2013

(51) Int. Cl. G06F 9/445

(52) U.S. Cl. CPC G06F 8/65
USPC 717/172

(57) ABSTRACT

A component software management system for a machine is disclosed. The component software management system has a software driven component located on-board the machine, a data system located off-board the machine, and a data system controller in communication with the software driven component and the data system. The data system controller is configured to detect a software or hardware mismatch, send a mismatch notification to the data system, and determine a current software update. The component software management system may then derive, from the current software update, a software calibration file, transmit the software calibration file, and install the software calibration file on the software driven component.

### TECHNICAL FIELD

This disclosure relates generally to a control system and, more particularly, to a machine control system having automatic software management.

### BACKGROUND

Machines such as autonomous construction equipment, passenger vehicles, vocational trucks, and other machines known in the art are often equipped with one or more components having software or hardware that require periodic service upgrades for operation of the components. The components work in concert with each other and are sometimes calibrated to function with specific versions of software and/or hardware in neighboring components within the same system. Software and hardware version mismatch between two or more components can cause the system to function in an unexpected way, or in some circumstances, may cause one or more components to stop functioning. Manually updating software after identification of a mismatch is time consuming and labor intense. Further, manual component software updates create opportunity for human error.

Currently, the software version for each individual component is recorded at a corresponding electronic control module on-board the machine, and has to be retrieved manually by a technician with module reading equipment. Maintaining a history of software and/or hardware versions for each component includes checking the software version of each component at the electronic control module, manually recording the software version, and subsequently tracking a software version history over time via an external tool such as a spreadsheet. A software and hardware version list is then generated and manually compared against a record of expected software and hardware versions to identify any mismatches. When a mismatch is spotted, appropriate action is then taken. This action can include manually connecting computing equipment to each machine and uploading updated software to connected components. Manual software updates can be difficult and prone to error in situations where few maintenance personnel manage large numbers of autonomous machines.

One exemplary method used to identify an incorrect or mismatched software update is described in U.S. Patent Application Publication No. US 2011/0214112 A1 (the '112 publication) filed by Vidal et al. on Feb. 26, 2010. The '112 publication describes a system in which software is diagnosed and updated via a notification tool that determines whether a software conflict exists, and notifies a user of any potential conflicts, faults, or other conditions that may arise due to the software update. The system described in the '112 publication then performs software repair, and updates other software or resources as appropriate.

Although the '112 publication describes a system for identifying a mismatched or incompatible software installation, it does not provide for system level management of software versioning for multiple machine components. Furthermore, the '112 publication appears to track and update entire system files instead of updating only the needed one or more bytes of information, and is silent on other important factors such as environmental checks that provide for safe file installation.

The system of the present disclosure is directed towards overcoming one or more of the problems as set forth above.

### SUMMARY

One aspect of the present disclosure is directed to a component software management system for a machine. The component software management system may include a software driven component located on-board the machine, a data system located off-board the machine, and a data system controller in communication with the software driven component and the off-board data system. The data system controller may be configured to automatically detect a software or hardware mismatch and send a mismatch notification to the data system when a mismatch is detected. The data system controller may then receive a current software update from the off-board data system, derive, from the current software update, a software calibration file, and install the software calibration file on the software driven component.

Another aspect of the present disclosure is directed to a computer-implemented method of managing a software version of a machine component. The method may include analyzing, using one or more processors, a machine component for at least one of a software and a hardware version mismatch. If a software or hardware version mismatch is detected, a notification may be sent to an off-board data system. A current software update may then be received from the off-board data system. One or more processors may then be used to derive a software calibration file from the current software update. The software calibration file may then be installed on the software driven component.

### BRIEF DESCRIPTION OF THE DRAWINGS

FIG. 1 is a schematic and pictorial illustration of an exemplary disclosed machine;

FIG. 2 is a diagrammatic illustration of an exemplary component software management system that may be used in conjunction with the machine of FIG. 1; and

FIG. 3 is a flowchart illustrating an exemplary disclosed method of operating the component software management system of FIG. 2.

### DETAILED DESCRIPTION

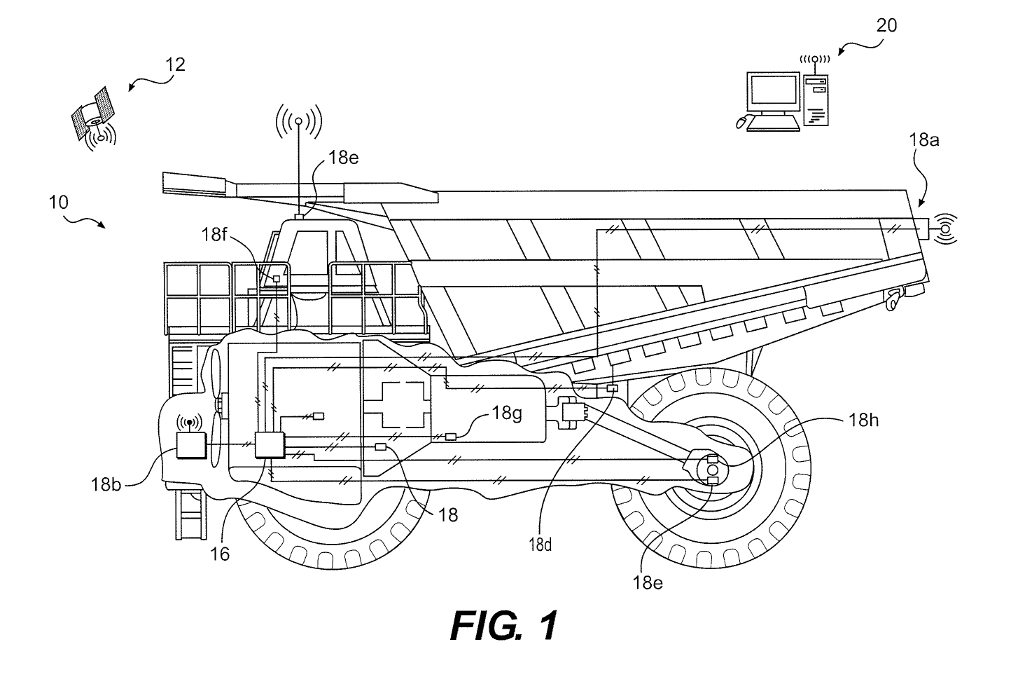

FIG. 1 illustrates an exemplary machine 10 for use in a worksite. Machine 10 may embody an autonomous, semi-autonomous or manually controlled mobile machine. For example, machine 10 may be an earth moving machine such as an off-highway haul truck (shown in FIG. 1), a wheel loader, a motor grader, or any other mobile machine known in the art. Machine 10 may alternatively embody a non-earth moving machine such as an on-road vehicle, a passenger vehicle, a stationary generator set, a pumping mechanism, or any other suitable operation-performing machine.

Machine 10 may have one or more software driven components 18 that facilitate its operation at the worksite. For the purposes of this disclosure, a software driven component 18 may be considered any component that utilizes software and/or hardware in its operation. Examples of software driven components 18 may include various auxiliary equipment such as a sensing device module 18a. Auxiliary equipment may be on-board the machine 10 to perform various tasks during machine 10 operation that aid in the application of the machine 10 on the worksite. For example, sensing device module 18 may be used to sense the physical surroundings of the machine 10 using lidar, radar and/or the like. Software drive components 18 may further include a locating device 18b, used to geographically locate the machine 10, and a communications module 18c, used to facilitate communication between the machine 10 and another device or system remotely located from the machine 10. Additional examples include a chassis control module 18d used to control operational aspects of a machine chassis, a brake control module 18e used to control operational aspects of a braking system, a steering control module 18f, a transmission control module 18g, a tire control module 18h, and an auxiliary equipment module (not shown). Other types of devices not named herein may be included on the machine 10, which may communicate with one another and/or communicate with other software driven components. While other devices are not explicitly named, it is to be understood that such devices may cooperate with one another, and may benefit from software and/or hardware compatibility matching between components.

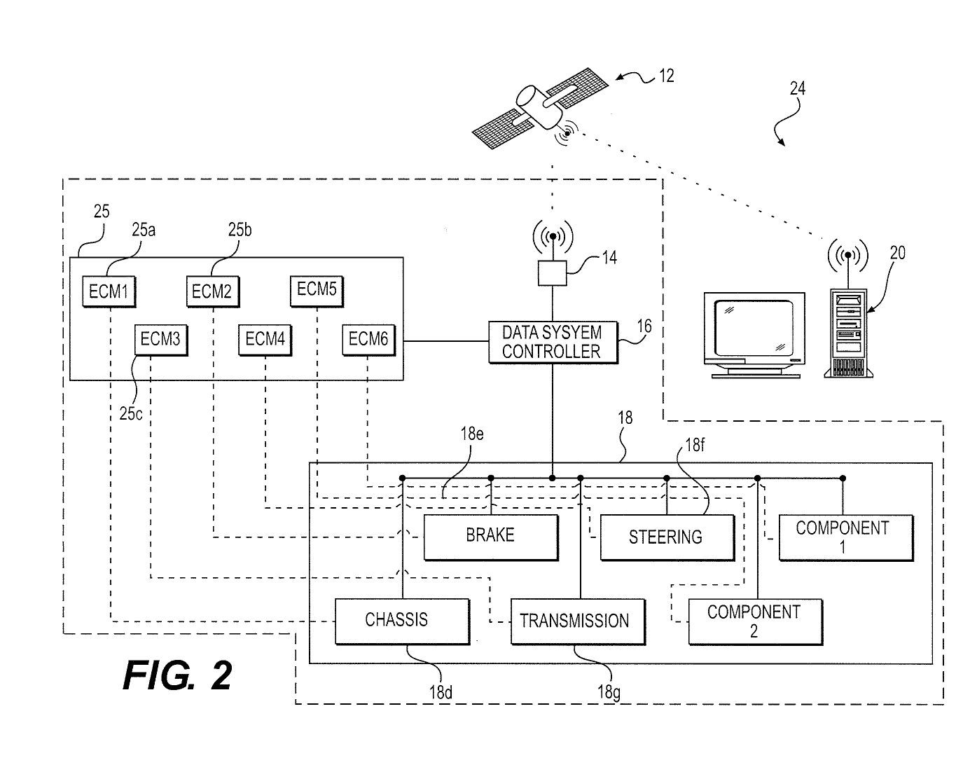

As shown in FIG. 2, one or more machine controllers 25 may be on-board the machine 10. A machine controller 25, embodied as an electronic control module (ECM), may be operably connected to one or more software driven components 18. For example, machine controller 25 may be in communication with a software driven component 18, such as a brake control module 18e, and together function as a brake control system that works in conjunction with an autonomous machine control system and/or operator interface (not shown). Machine controllers 25 may communicate with one another, and/or communicate with an on-board data system controller 16.

Data system controller 16 may coordinate the function of various machine controllers 25 and/or software driven components 18. For example, software driven components 18 may report to machine controllers 25, and each of machine controllers 25 may report to data system controller 16. Data system controller 25 may be responsible for collecting information regarding the software driven components 18 and for processing the information. As an example, information collected by data system controller 16 may include any one or more of various operational information, such as software version, hardware version, operational status, component wear, component safety, and or any other information in connection with the operation and function of component 18.

Data system controller 16 may also receive a current software update, a software calibration file and/or other types of data from an external source via wireless communication device 14, and compare the current software update received with existing software on one or more software driven components 18. Further, data system controller 16 may be configured to receive a current software update, a software calibration file and/or other types of data via a wired connection operatively connected to an interface on machine 10. A current software update may be a later version of software, a software patch for currently installed software, and/or a different software not previously installed on machine 10, etc. A software calibration file can be any part of a current software update that is derived from the current software update. A software calibration file can be some or all data contained in the current software update.

Data system controller 16 may include any means for monitoring, recording, storing, indexing, processing, and/or communicating the operational aspects of machine 10 described above. These means may include components such as, for example, a memory, one or more data storage devices, a central processing unit, or any other components that may be used to run an application. Furthermore, although aspects of the present disclosure may be described generally as being stored in memory, one skilled in the art will appreciate that these aspects can be stored on or read from different types of computer program products or computer-readable media such as computer chips and secondary storage devices, including hard disks, optical media, CD-ROM, or other forms of non-transitory computer readable media.

For example, data system controller 16 may be configured to derive a software calibration file from a current software update that has been received from a source operatively connected to machine 10. Further, data system controller 16 may automatically coordinate the transfer and installation of the software calibration file onto software driven component 18.

Data system controller 16 may also include a means for communicating with an off-board data system 20. For example, data system controller 16 may include hardware and/or software that enables sending and receiving of data messages through a direct data link (not shown) or a wireless communication link 14. The wireless communications may include satellite 12, cellular, infrared, and any other type of wireless communications that enable data system controller 16 to exchange information with off-board data system 20. It is contemplated that a separate module may be included within data system controller 16 to facilitate the communication of data between data system controller 16 and off-board data system 20, if desired. Further, data system controller 16 may be operatively connected to another on-board or off-board computer in order to receive information, such as, for example, data and/or user instructions.

Data system controller 16 may also include a means for securely communicating with an on-board operator, an off-board operator, and/or maintenance personnel. Data system controller 16 may also authenticate an authorized user. Through an operatively connected user interface (not shown), an operator or maintenance personnel may be authenticated with a password, a key fob, smart card, or some other security protocol known in the art.

Off-board data system 20 may represent one or more computing systems of a business entity associated with machine 10, such as a worksite operator, manufacturer, dealer, retailer, owner, service provider, or any other entity that generates, maintains, sends, and/or receives information associated with machine 10. The one or more computing systems may include, for example, a laptop, a work station, a mobile computing device, a mainframe, and other computing systems known in the art.

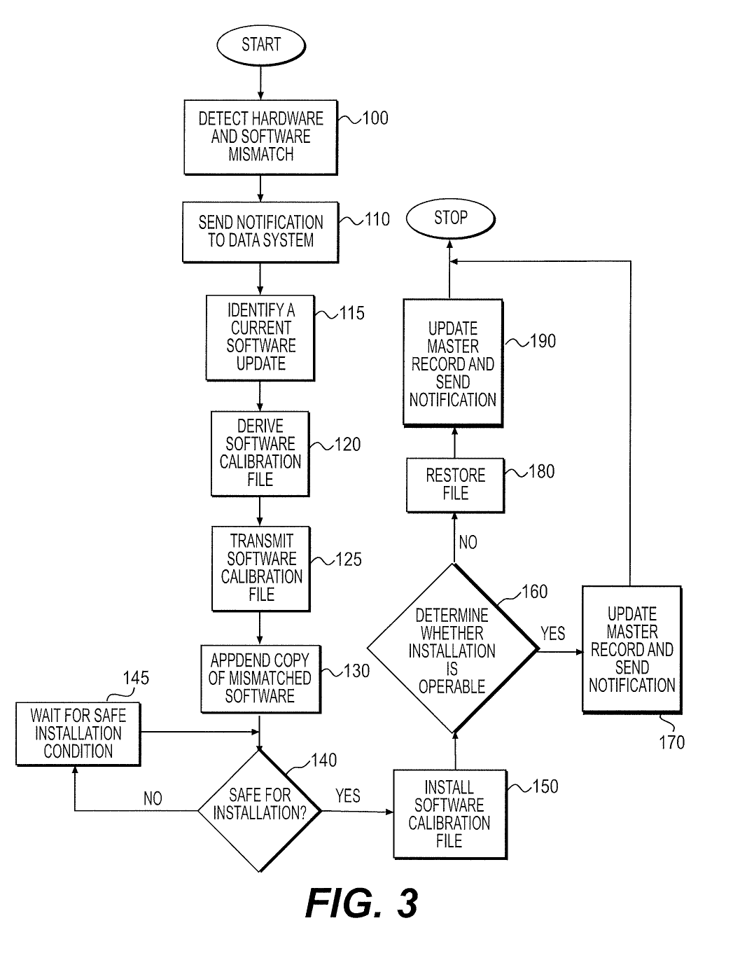

FIG. 3 illustrates a flowchart describing a method of managing the software and/or hardware of 18. FIG. 3 will be discussed in the following section to further illustrate the disclosed system and its operation.

### INDUSTRIAL APPLICABILITY

The disclosed method and system may provide an accurate and reliable way for managing software and hardware versions in on-board software driven components. Specifically, because the disclosed system and method provide for automatic software version management, the amount of manual effort expended to identify software version mismatch, install a current software update, and record software version history of machine components may be low, and the likelihood of error may be reduced. The operation of control system having automatic software management 24 will now be described with respect to FIG. 3.

As illustrated in the flowchart of FIG. 3, during the first step of the component software management process, control system 24 may detect a software and hardware mismatch (Step 100). In one embodiment, Step 100 may begin automatically when a new software driven component is installed in machine 10. In yet another embodiment, the detection process may begin automatically when machine 10 is started and/or keyed on. In another embodiment, the process may begin when a specific interval of time has elapsed since a previous process cycle. For example, while machine 10 is in operation, control system 24 may collect and analyze the information at a predetermined time interval of five seconds. In yet another embodiment, the process may begin when a start process signal is received by the on-board control system from an external source, such as off-board data system 20. Data system controller 16 may determine that one or more software driven components has been newly installed by monitoring a power and/or communication signal sent to or received from the component 18 by machine controller 25. Alternatively, the component software management process may be triggered in other ways. For example, the process may be manually triggered by a service technician upon installation, if desired. The component software management process may also be manually triggered by a request from an individual, such as a mine operator, who has an operative connection to control system 24. The request from an individual may cause control system 24 to return version information to the operator even if one or more software and hardware mismatch has not been detected. Accordingly, the software mismatch detection process is configured to commence following any one or more of the events described above.

In the event that Step 100 has been triggered, data system controller 16 may initiate automatic collection of software and hardware information. The collected software and hardware information may include component information such as, for example, an identifying serial number or other identification, a model number, a hardware version number, a software version number, a software and/or hardware release date, a software and/or hardware expiration date, a software and/or hardware group description, a fabrication or testing date or facility, an operating system version, a firmware version, and/or other related component information. The collected information may also include user information, such as, information identifying the particular machine 10 into which software driven component 18 is installed, information associated with the selling or servicing dealership associated with the machine 10 and/or any component and/or systems installed on the machine 10, customer information (i.e., name, billing address, intended work location, contact information, and/or the like), and other user-related information known in the art. Control system 24 may automatically collect the component information via electronic communication via optical, infrared or magnetic scanning of external or internal indices placed on or programmed into machine 10 during fabrication or installation. Detecting a software and hardware mismatch may further include identifying one or more elements of the information that has changed since a previous analysis, and comparing the one or more elements of information against a master record of compatible component software and hardware matches. Step 100 may be processed by data system controller 16, or other processing means within control system 24.

When a software and hardware version mismatch is detected, data system controller 16 may send a notification to off-board data system 20 (Step 110). The notification may contain a plurality of information from machine 10, including the mismatch information and/or the automatically-collected information used by data system controller 16 in detecting software and hardware mismatch.

After receiving a notification from machine 10, off-board data system 20 may identify a current software update based on any of the plurality of information received in the notification (Step 115). Accordingly, off-board data system may contain matching records that match current software updates with a corresponding software driven component 18. The matching records may be used by off-board data system 20 to identify an appropriate current software update. According to one embodiment, the matching records may be stored and/or maintained on any one or more processors of control system 24. Off-board data system 20 may also contain a library of all software installed or previously installed on software driven component 18.

Once a current software update is identified, control system 24 may derive a software calibration file (Step 120) by comparing a copy of a currently-installed file (the mismatched software) on software driven component 18 with the current software update. Control system 24 may derive the software calibration file by making a byte-by-byte comparison between the copy of mismatched software and the current software update. When off-board data system 20 discovers one or more bytes of information that differs between the two files, a software calibration file may be created that omits the one or more bytes of information from the current software update found to be identical to the corresponding bytes of information on the mismatched software, and includes the bytes of information from the current software update found to be different from the corresponding bytes of information on the mismatched software. In the event that the mismatched software contains bits not present in the software update (or vice versa) a literal comparison may not be made, but the missing bits may be added to the software calibration file. If the mismatched software contains bits not present in the current software update, the calibration file may contain instructions to over-write or remove the un-needed bits when a copy of the mismatched software is later appended for installation on software driven component 18.

After deriving the software calibration file, off-board data system 20 may then transmit the software calibration file to machine 10 (Step 125). The software calibration file contains the information needed to modify a copy of the mismatched software stored on machine 10, in order to render the mismatched software identical to the current software update. Generally, the software calibration is not a full copy of the current software update, but only information necessary to append, overwrite and/or delete the different parts of the mismatched software. In this way, bandwidth on the wireless communication network may be conserved by sending only the dissimilar bytes of information needed to append a copy of the mismatched software on data system controller 16 with the software calibration file. However, the software calibration file may be an entirely different software, and/or may be a full copy of the current software update.

After control system 24 transmits the software calibration file, data system controller 16 may append a copy of the mismatched software, in order to create a copy of the current software update (Step 130) on-board machine 10. The software calibration file (now appended) is stored on data system controller 16 until installation on software driven component 18. It should be understood that the software calibration file contains data and instructions sufficient to transform a copy of the mismatched software into a new file that mirrors the current software update.

Data system controller 16 may now determine whether machine 10 is in a state safe for installation of the software calibration file (Step 140). Machine 10 may be in operation during the various steps of FIG. 3, such as software and hardware mismatch detection (Step 100), sending a notification (Step 110), identifying a current software update (Step 115), deriving the software calibration file (Step 120), transmitting the software calibration file (Step 125), or appending a copy of the mismatched software with the software calibration file (Step 130). However, it may be disadvantageous to install the software calibration file while machine 10 is in operation. Therefore, control system 24 may automatically run a “safety check” algorithm to determine whether the machine 10 is in a non-operational state, and therefore safe for installation (Step 140). For example, machine 10 may be in a non-operational state when it is parked or being maintained by personnel, etc. The safety check algorithm may determine the physical location of machine 10 using locating device module 18b. The location information may indicate an operational state and/or safety condition based on whether machine 10 is located on a work site or in a maintenance area such as a garage, or whether machine 10 is in motion.

At step 140, control system 24 may request user input from human personnel, such as a mine operator, as part of the safety check algorithm performed by control system 24 prior to installing the software calibration file. The user input may indicate whether the operational status of the machine allows for a safe installation of the software calibration file. Accordingly, control system 24 may receive either an affirmative or a negative user confirmation, and proceed with the installation in response to the affirmative user confirmation.

Control system 24 may automatically wait for a safe installation condition (Step 145) before installation of the software calibration file. When control system 24 determines that machine 10 is in a non-operational state (in a safe condition for installation), data system controller 16 may install the software calibration file (Step 150).

Following the installation of the software calibration file, data system controller 16 may determine whether the installation is operable (Step 160). Off-board data system 20, data system controller 16, or another processor of control system 24 may make this determination. A operable installation of the calibration file may result in a fully-operational software driven component 18. If software driven component 18 is rendered at least partly inoperative as a result of the installation (simply stated, the component 18 does not fully perform its intended function), then the installation of the calibration file at Step 150 may not be considered operable.

At Step 160, control system 24 may also determine whether the installation is operable based on whether the software update is manufacturer-authorized software. Manufacturer-authorized software may originate from the original equipment manufacturer, or from an authorized supplier to the original manufacturer. When the software update is altered in some way from the original manufacturer's software release, or originates from a non-authorized source, control system 24 may consider an installation to be an inoperable installation.

When control system 24 determines that the installation of the calibration file is operable, data system controller 16 may update a master record of the software version history of software driven component 18 and send a notification to off-board data system 20 (Step 170). The notification may include a copy of the master record. The master record may include, but is not limited to any one or more of: component identification information that uniquely identifies the component 18, the date that component 18 was installed, a name of component 18, a description of component 18, machine 10 identification, machine 10 class information, a hardware version, a hardware serial number, a firmware version, an operating system version, a software name, a software version, a release date of software and/or hardware, a software expiration date, and/or a group description.

Control system 24 may maintain a library of current and previous file versions for each software driven component 18. The library may be stored on-board and/or off-board machine 10. When control system 24 determines that an installation of the software calibration file renders the software driven component at least partly inoperative, control system 24 may restore a copy of the mismatched software by copying a copy from the library back to the affected software driven component 18 (Step 180).

Once a file from the library is restored to software driven component 18, data system controller 16 may update a master record of the version history for each software driven component 18, and send a notification to off-board data system 20 (Step 190).

The notification may include a copy of the master record.

The flow chart depicted in FIG. 3 shows one possible order in which control system 24 described herein is operated. Those skilled in the art will appreciate that a different logical order may be utilized in the practice of the presently disclosed control system 24, if desired. It will be apparent to those skilled in the art that various modifications and variations can be made to the method and system of the present disclosure. Other embodiments of the method and system will be apparent to those skilled in the art from consideration of the specification and practice of the method and system disclosed herein. It is intended that the specification and examples be considered as exemplary only, with a true scope of the disclosure being indicated by the following claims and their equivalents.

What is claimed is:

1. A component software management system for a machine, comprising:
a software driven component located on-board the machine;
a data system located off-board the machine; and
a data system controller in communication with the software driven component and the data system located off-board the machine, the data system controller being configured to:
detect a mismatched software;
send a mismatch notification to the data system located off-board the machine;
determine a current software update;
derive, from the current software update, a software calibration file;
transmit the software calibration file; and
install the software calibration file on the software driven component.

2. The component software management system of claim 1, wherein the data system controller is located on-board the machine and is in communication with the software driven component via a machine controller.

3. The component software management system of claim 1, wherein the software calibration file is derived by:
comparing bytes of the current software update to bytes of the mismatched software; and
creating the software calibration file, wherein the software calibration file:
omits bytes of information from the current software update found to be identical to corresponding bytes of information on the mismatched software;
includes bytes of information from the current software update found to be different from corresponding bytes of information on the mismatched software; and
includes instructions to remove any bytes of information that are not part of the current software update.

4. The component software management system of claim 1, wherein the data system controller is configured to automatically perform a safety check prior to installing the software calibration file on the software driven component.

5. The component software management system of claim 4, wherein the data system controller is further configured to:
determine whether the machine is in a non-operational state; and
install the software calibration file when the data system controller has determined that the machine is in the non-operational state.

6. The component software management system of claim 5, wherein the data system controller is configured to:
restore the mismatched software to the software driven component when installation of the software calibration file renders the software driven component at least partly inoperative; and
send a notification to the data system located off-board the machine.

7. The component software management system of claim 3, wherein the data system controller is configured to:
authenticate an authorized user;
request user input regarding whether the current software update creates any known software and hardware mismatches;
receive either an affirmative or a negative user confirmation; and
proceed with installation in response to the affirmative user confirmation.

8. The component software management system of claim 4, wherein the data system controller is configured to determine if the current software update is manufacturer-authorized software.

9. The component software management system of claim 1, wherein the data system controller is further configured to:
update a master record with information related to software installed on the software driven component; and
automatically send the master record to the data system located off-board the machine.

10. The component software management system of claim 1, wherein the software calibration file includes software for a plurality of software driven components.

11. A computer-implemented method of managing a software version of a software driven component for a machine, comprising:
analyzing, by one or more processors on a data system controller, the software driven component for at least one of a software and hardware version mismatch;
sending a notification to a data system located off-board the machine when a mismatched software is detected;
determining, using the one or more processors, a current software update;
deriving, using the one or more processors, a software calibration file from the current software update;
transmitting the software calibration file; and
installing, using the one or more processors, the software calibration file on the software driven component.

12. The method of claim 11, wherein the software calibration file is derived by:
comparing bytes of the current software update to bytes of the mismatched software; and
creating the software calibration file, wherein the software calibration file:
omits bytes of information from the current software update found to be identical to corresponding bytes of information on the mismatched software;
includes bytes of information from the current software update found to be different from corresponding bytes of information on the mismatched software; and
includes instructions to remove any bytes of information that are not part of the current software update.

13. The method of claim 11, further including performing a safety check prior to installation of the software calibration file on the software driven component.

14. The method of claim 13, including:
determining whether the machine is in a non-operational state; and
installing the software calibration file when the data system controller has determined that the machine is in the non-operational state.

15. The method of claim 14, further including:
restoring the mismatched software to the software driven component when the installation of the software calibration file renders the software driven component at least partly inoperative; and
notifying the data system located off-board the machine.

16. The method of claim 14, including:
authenticating an authorized user;
requesting input from the authorized user regarding whether the current software update creates a software and hardware version mismatch;
receiving either an affirmative or a negative user confirmation; and
proceeding with the installation in response to the affirmative user confirmation.

17. The method of claim 13, including determining if the current software update is manufacturer-authorized software.

18. The method of claim 13, including
automatically updating a master record with information related to software installed on the software driven component; and
automatically sending the master record to the data system located off-board the machine.

19. The method of claim 13, wherein the software calibration file includes software for a plurality of software driven components.

20. A control system for a machine, comprising:
a software driven component;
a data system controller in communication with the software driven component and configured to automatically collect information comprising at least one of a software and hardware version of the software driven component;
a data system located off-board the machine; and
a data system controller located on-board the machine in communication with the software driven component, the data system controller and the data system located off-board the machine, the data system controller being configured to:
detect a software and hardware mismatch;
send a mismatch notification to the data system located off-board the machine;
determine a current software update;
derive, from the current software update, a software calibration file;
transmit the software calibration file;
determine whether the machine is in a non-operational state; and
install the software calibration file on the software driven component when the machine is in the non-operational state.
